(19) United States
(12) Patent Application Publication
(10) Pub. No.: US 2025/0309712 A1
(43) Pub. Date: Oct. 2, 2025

(54) Rotor Design for High-Speed Applications Using Segmented Magnets

(71) Applicant: Conifer Systems, Inc., Middletown, DE (US)

(72) Inventors: Yateendra B Deshpande, Sunnyvale, CA (US); Padmanabhan Kumar, Fremont, CA (US); Brett Hazama Lum, Sunnyvale, CA (US)

(21) Appl. No.: 19/093,761

(22) Filed: Mar. 28, 2025

Related U.S. Application Data
(60) Provisional application No. 63/572,141, filed on Mar. 29, 2024.

(51) Int. Cl. H02K 1/28; H02K 1/2795

(52) U.S. Cl. CPC H02K 1/28; H02K 1/2795

(57) ABSTRACT

Systems and methods related to rotor design for high-speed applications using segmented magnets are disclosed herein. A rotor for an axial electric machine may include a rotor frame and a set of permanent magnets. In specific embodiments, a pattern of adhesive may adhere the magnets to the rotor frame. The adhesive may be in contact with an outer surface (away from the center of the rotor) of the magnets. In specific embodiments, a set of pockets may be formed in the rotor frame with the magnets being placed in the pockets. The magnets may include a set of flat outer faces that are in contact with the outer rim of the rotor frame. In specific embodiments, the magnets may be located between spokes on the rotor frame. The embodiments of the rotors described herein may be better suited for the forces of axial machine operation.

### CROSS REFERENCE TO RELATED APPLICATIONS

This application claims the benefit of U.S. Provisional Patent Application No. 63/572,141, filed Mar. 29, 2024, which is incorporated by reference herein in its entirety for all purposes.

### BACKGROUND

Axial flux motors are currently making inroads as the prime movers of the drivetrain of electric automobiles. For such applications, axial flux motors are ideal as prime movers due to the size and form factor attributable to their axially compact designs. Their form factor is also beneficial in certain other vehicle classes such as electric motorcycles, mopeds, and electric bicycles owing to their ability to be packaged more efficiently relative to the wheels of such vehicles. Furthermore, in the case of electric motors used for power generation in conjunction with internal combustion engines, the overall axial length of the engine and electric machine system is a challenge to package within tight spaces (e.g., passenger cars or tight spaces for installation in buildings). Accordingly, axial flux electric machines provide a key packaging benefit in these applications as well.

Spinning an axial electric machine at high speeds produces more power because the mechanical power output of the machine is defined by the mathematical product of torque and speed. Increased power is desirable for an electric machine so increased speed is likewise desirable. In addition, increasing the speed of an axial electric machine can lead to the use of smaller electric motors which can decrease the cost and weight of the electric motor. While torque can be increased independently, an increase in torque necessitates higher air-gap force production and therefore larger motors. As such, higher speed operation of an axial electric motor leads to a more compact motor for the same power output. However, the speed of an axial electric machine cannot be increased indefinitely as high-speed operation places tension on the moving parts such as by increasing the friction of ball bearings that allow the rotor to rotate and increasing the centrifugal force experienced by the components of the rotor. As such, methods and systems which facilitate high-speed operation represent a significant improvement for the field of axial electric machines.

### SUMMARY

This disclosure relates to rotor design for high-speed applications using segmented magnets. Systems and methods related to rotors for axial electric machines are disclosed herein. The axial electric machines can be electric motors or electric generators. In specific embodiments, the electric machines are high speed electric machines that operate at a rotational speed of at least 8000 rotations per minute (RPM). In specific embodiments, the axial electric machine can be capable of high-speed operation while using ceramic magnets on the rotor (e.g., ferrite magnets) which are less expensive and more environmentally friendly than rare earth magnets, but which are generally considered prone to fracturing at high-speed rotation. Specific rotor configurations and related approaches are disclosed herein which allow for rotors to be capable of reliable high-speed operation. Specific rotor configurations and related approaches are disclosed herein which allow for rotors that are capable of reliable high-speed operation even with the use of ceramic magnets that would otherwise be subject to damage from the forces imparted to the magnets by high-speed operation.

In axial flux electric machines, the airgap between the stator and rotor needs to be as small as possible. In the case of axial flux electric motors, typical airgaps are between 0.1 mm to 1.5 mm. A smaller airgap is better as it allows better magnetic flux linkage between stator and rotor and allows for higher torque production for the same current. However, if the rotor physically touches the stator, that can cause friction thereby causing losses, excess local heating, and additional stresses which could lead to fracture of magnets or stator pole pieces. When a rotor rotates at high speeds, the rotor structure can deflect in a way that would allow parts of the rotor or magnets to approach closer to the stator and potentially touch the stator. To account for this eventuality, the nominal airgap needs to be increased, leading to reduced potential performance. Using specific embodiments of the inventions disclosed herein, such as those in which a stator is enhanced through the use of stiffening spokes to reduce deflection, a minimal nominal air gap can be maintained in the design, thereby improving potential performance.

The embodiments disclosed herein can operate with various different types of electric machines. The disclosed rotors can be utilized as the side rotors in a single yokeless motor, as the center rotor and two side motors in a tandem yokeless motor, or as the center rotor in a single yoked motor. As used herein, the term yokeless and yoked refer to stator configurations that respectively produce magnetic flux on two sides or one side of the stator along the axial direction. However, different stator designs that produce magnetic flux in such a pattern can be used instead regardless of the use of a yoke in the stator or not. The rotors disclosed herein can also be used in analogous electric generators. There may be slight variations in the designs for the rotors disclosed herein that are applicable for use in either a center or side rotor.

In specific embodiments of the invention, the permanent magnets used on the stator of a high-speed rotor are ceramic magnets (e.g., ferrite magnets) instead of rare earth magnets. The elimination of rare earth magnets on these motors is desirable due to the higher cost of processing rare earth metals as well as the toxic waste side products which result from rare earth extraction processes. In these embodiments, the rotor can be designed in such a way that the magnets can withstand the stresses induced due to the high speed of the rotor. For example, ceramic magnets such as ferrite magnets exhibit excellent compressive strength (e.g., approximately 700 Mega-Pascals of compressive strength (MPa)) and very low tensile strength (e.g., approximately 35 MPa of tensile strength). As a result, conventional rotor construction leads to excessive tensile stress and failure of the ceramic magnets at relatively low rotor speeds. Specific embodiments of the invention disclosed herein address this issue with conventional rotor construction and protect the magnets from excessive tensile stress even during high-speed operation. Various aspects of rotor design described herein may also be beneficial to rotors with rare earth magnets; the embodiments are not limited to use of ceramic magnets.

In specific embodiments of the invention, the permanent magnet of the rotor is segmented into multiple pieces which are attached to a structural rotor component that can be referred to herein as the rotor frame. These approaches contrast with approaches in which the rotor magnet is one continuous piece with varying polarity. Breaking the magnets into pieces reduces the tensile stress experienced by the magnetic portion of the rotor at various points around the surface of the rotor as the centrifugal force on one side of the rotor does not pull the magnet on the opposite side in the opposite radial direction. Instead, all portions of the magnet are being pulled in a single direction away from the center which decreases the tensile stress experienced by the magnets. Additionally, the tensile stress is reduced as there is less pulling tangentially to the radial direction of the magnet as the centrifugal force on the portions of the rotor that are 90 degrees away in either direction do not pull the magnets apart in opposite directions.

In specific embodiments of the invention, the rotor frame can include pockets that are designed to contain the permanent magnets. The pockets can assist in keeping the magnets in place on the rotor. Additionally, the pockets can include spokes between an outer and inner rim of the rotor frame to provide additional structural rigidity to the rotor. The spokes can be thicker than the main body of the frame. The spokes can be designed to maintain structural rigidity of the rotor despite the fact the main body of the frame is thinner at the points in which the pockets were formed. The spokes can prevent the rotor from bending away from the air gap due to the rotational stresses of the rotor. The spokes can also prevent spreading of the magnet around the arc of the rotor by being in contact with both sides of the magnets and preventing the creation of tensile stress from such spreading. An outer rim of the rotor frame can be configured to form an edge of a pocket on the rotor. The outer rim can be connected to the spokes, which may add structural rigidity to the outer rim. In specific embodiments the permanent magnets will be in contact with the outer rim and thereby the outer rim may prevent the magnets from flying out due to centrifugal force acting on the magnets.

In specific embodiments of the invention, a rotor for an axial electric machine is provided. The rotor comprises: a rotor frame, a set of permanent magnets, and a pattern of adhesive that adheres the set of permanent magnets to the rotor frame, and that is in contact with an outer surface of the set of permanent magnets and is not in contact with an inner surface of the set of permanent magnets, wherein: (i) the outer surface faces away from a center of the rotor in a radial direction of the axial electric machine; and (ii) the inner surface faces towards the center of the rotor in the radial direction of the axial electric machine.

In specific embodiments of the invention, a rotor for an axial electric machine is provided. The rotor comprises: a rotor frame, a set of permanent magnets, and a set of pockets formed in the rotor frame, wherein the set of permanent magnets are placed in the set of pockets. The rotor further comprises an outer rim of the rotor frame, wherein the set of permanent magnets includes a set of flat outer faces, and the set of flat outer faces are in contact with the outer rim of the rotor frame.

In specific embodiments of the invention, a rotor for an axial electric machine is provided. The rotor comprises: a rotor frame, a set of permanent magnets, a set of spokes on the rotor frame, and an outer rim of the rotor frame, wherein the set of spokes are connected to the outer rim. The permanent magnets in the set of permanent magnets are located between the spokes in the set of spokes.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of axial flux motors in accordance with specific embodiments of the inventions disclosed herein.

FIG. 2 provides an example of a side rotor, a side rotor frame, and magnets in accordance with specific embodiments of the inventions disclosed herein.

FIG. 3 provides an example of a center rotor and a center rotor frame in accordance with specific embodiments of the inventions disclosed herein.

FIG. 4 provides an example of the shape of a permanent magnet in accordance with specific embodiments of the inventions disclosed herein.

FIG. 5 provides an example of an adhesive pattern on an end rotor in accordance with specific embodiments of the inventions disclosed herein.

FIG. 6 provides an example of an adhesive pattern on a center rotor in accordance with specific embodiments of the inventions disclosed herein.

FIG. 7 provides an example of ledges that create air gaps between permanent magnets and spokes in a rotor in accordance with specific embodiments of the inventions disclosed herein.

FIG. 8 provides an example of a 4-pole rotor with pairs of permanent magnets in accordance with specific embodiments of the inventions disclosed herein.

FIG. 9 provides an example of a design for reducing flux leakage for a 4-pole rotor in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for rotor design for high-speed applications using segmented magnets in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to rotors for axial electric machines are disclosed herein. The axial electric machines can be electric motors or electric generators. In specific embodiments, the electric machines are high speed electric machines. In specific embodiments, the axial electric machine can be capable of high-speed operation while using ceramic magnets on the rotor (e.g., ferrite magnets) which are less expensive and more environmentally friendly than rare earth magnets, but which are generally considered prone to fracturing at high-speed rotation. Specific rotor configurations and related approaches are disclosed herein which allow for rotors that are capable of reliable high-speed operation even with the use of ceramic magnets that would otherwise be subject to damage from the forces imparted to the magnets by high-speed operation. However, the approaches disclosed herein may not be limited to use with ceramic magnets. Many types of permanent magnets, including neodymium magnets, may be used.

In axial flux electric machines, the airgap between the stator and rotor needs to be as small as possible. A smaller airgap is better as it allows better magnetic flux linkage between stator and rotor and allows for higher torque production for the same current. However, if the rotor physically touches the stator, that can cause friction thereby causing losses, excess local heating, and additional stresses which could lead to fracture of magnets or stator pole pieces. Using specific embodiments of the inventions disclosed herein, such as those in which a stator is enhanced through the use of stiffening spokes to reduce deflection, a minimal nominal air gap can be maintained in the design, thereby improving potential performance.

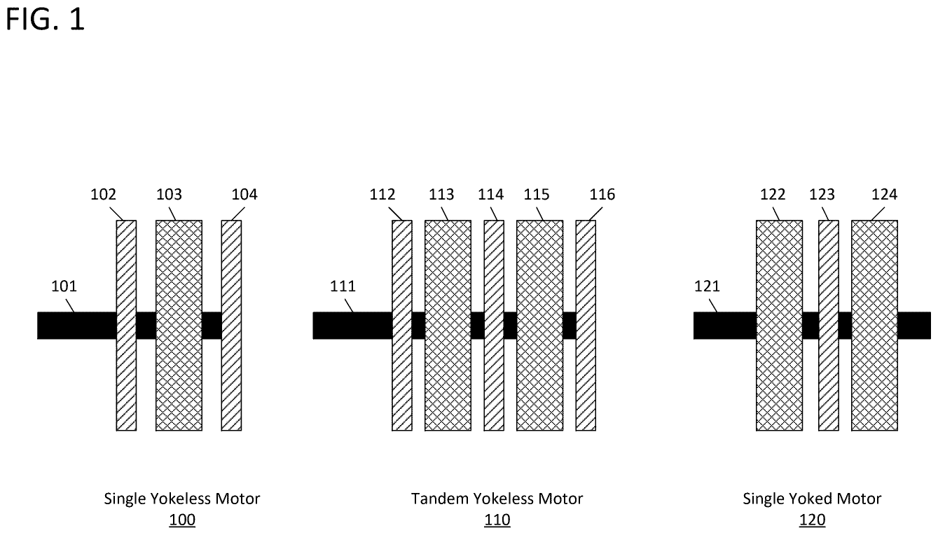

FIG. 1 illustrates examples of axial flux motors in accordance with specific embodiments of the inventions disclosed herein. Single yokeless motor 100 includes axle 101, side rotor 102, stator 103, and side rotor 104. Tandem yokeless motor 110 includes axle 111, side rotor 112, stator 113, center rotor 114, stator 115, and side rotor 116. Single yoked motor includes axle 121, stator 122, center rotor 123, and stator 124. The rotors, stators, and axles disclosed herein may be used in various types of electric machines, such as single yokeless motor 100, tandem yokeless motor 110, and single yoked motor 120. Side rotors and center rotors may have slightly different designs. As used herein, the term yokeless and yoked refer to stator configurations that respectively produce magnetic flux on two sides or one side of the stator along the axial direction. However, different stator designs that produce magnetic flux can be used regardless of the use of a yoke in the stator or not. The rotors disclosed herein can also be used in analogous electric generators. The embodiments disclosed herein can operate with various different types of electric machines. The disclosed rotors can be utilized as the side rotors in a single yokeless motor, as the center rotor and two side rotors in a tandem yokeless motor, or as the center rotor in a single yoked motor.

In specific embodiments of the invention, stators (such as stators 103, 113, 115, 122, and 124) may use ceramic magnets (e.g., ferrite magnets). The rotors (such as rotors 102, 104, 112, 114, 116, and 123) can be designed in such a way that the magnets can withstand the stresses induced due to the high speed of the rotors. The permanent magnet of each rotor may be segmented into multiple pieces which may be attached to the corresponding rotor frame. Breaking the magnets into pieces reduces the tensile stress experienced by the magnetic portion of the rotor at various points around the surface of the rotor.

In specific embodiments of the invention, the rotor frame (e.g., of rotors 102, 104, 112, 114, 116, and 123) can include pockets that are designed to contain permanent magnets. The pockets can assist in keeping the magnets in place on the rotor. Additionally, the pockets (e.g., the sides of the pockets, part of the rotor frame) can include spokes between an outer and inner rim of the rotor frame to provide additional structural rigidity to the rotor. The spokes can be thicker than the main body of the frame. The main body of the frame, in the case of a side rotor (such as rotors 102, 104, 112, and 116), can be referred to as the “back iron” of the rotor. The spokes can be designed to maintain structural rigidity of the rotor despite the fact the main body of the frame is thinner at the points in which the pockets were formed. In specific embodiments of the invention, the rotor frame (e.g., of each of rotors 102, 104, 112, 114, 116, and 123) can include an outer rim. The outer rim can be configured to come into contact with an outer edge of the permanent magnets. The outer rim can be configured to form an edge of a pocket on the rotor. In specific embodiments, the permanent magnets may be in contact with the outer rim and thereby the outer rim may prevent the magnets from flying out due to centrifugal force acting on the magnets. In specific embodiments, the outer rim can be a thicker region of the material that is used to form the main body of the rotor. In specific embodiments, the outer rim may be a different type of material than that which is used to form the main body of the rotor.

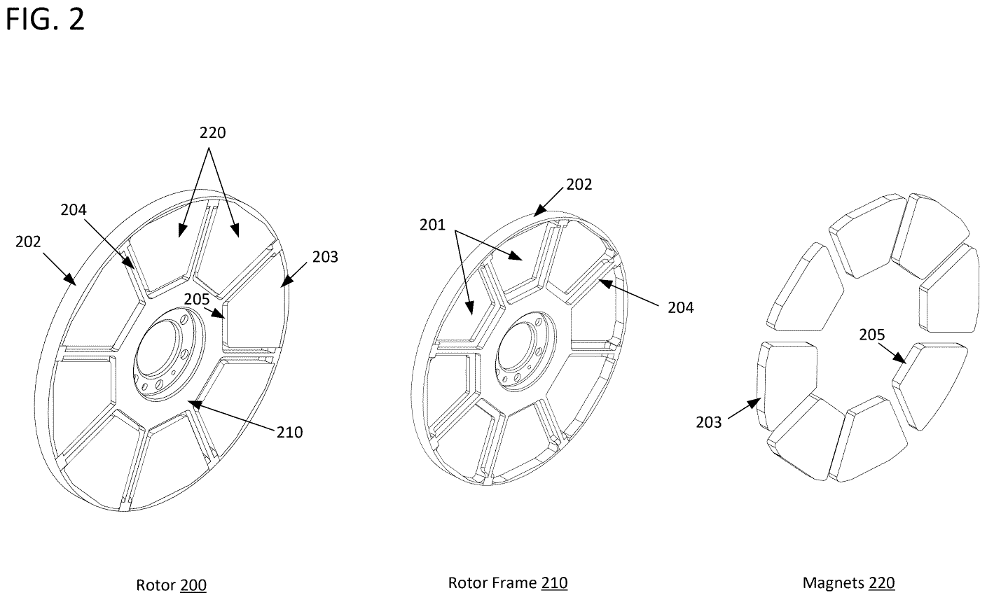

FIG. 2 illustrates an example of side rotor 200, side rotor frame 210, and magnets 220 in accordance with specific embodiments of the inventions disclosed herein. Side rotor 200 may be an example of side rotor 102, 104, 112, or 116. Rotor 200 shows permanent magnets 220 placed in pockets 201 of rotor frame 210. Rotor frame 210 may be a structural rotor component. In specific embodiments, rotor 200 may be an 8-pole rotor. Magnets 220 (and spokes 204) may be evenly spaced in rotor frame 210 and may alternate polarities. In other embodiments, a 4-pole rotor may be used. In specific embodiments, rotor 200 may not have spokes 204. In specific embodiments, magnets 220 may be located between spokes 204. FIG. 2 is exemplary only, and changes may be made to various aspects of the design depicted.

In specific embodiments, magnets 220 may be neodymium magnets. In specific embodiments, magnets 220 may be ceramic magnets (e.g., ferrite magnets) instead of rare earth magnets. The elimination of rare earth magnets on these motors is desirable due to the higher cost of processing rare earth metals as well as the toxic waste side products which result from rare earth extraction processes. Rotor 200 can be designed in such a way that magnets 220 can withstand the stresses induced due to the high speed of rotor 200. For example, ceramic magnets such as ferrite magnets exhibit excellent compressive strength (e.g., approximately 700 Mega-Pascals (MPa) of compressive strength) and very low tensile strength (e.g., approximately 35 MPa of tensile strength). As a result, conventional rotor construction leads to excessive tensile stress and failure of the ceramic magnets at relatively low rotor speeds. Specific embodiments of the invention disclosed herein address this issue and protect the magnets from excessive tensile stress even during high-speed operation. However, the rotors discussed herein are not limited to ceramic magnets, as benefits may also arise for rare earth magnets.

Permanent magnets 220 of rotor 200 are separate pieces which are attached to rotor frame 210. This approach contrasts with approaches in which the rotor magnet is one continuous piece with varying polarity. Using multiple smaller magnets (e.g., breaking the typical large magnet into pieces) reduces the tensile stress experienced by the magnetic portion of the rotor at various points around the surface of the rotor as the centrifugal force on one side of the rotor does not pull the magnet on the opposite side in the opposite radial direction away from the center. Instead, all portions of the magnet are being pulled in a single direction away from the center which decreases the tensile stress experienced by the magnets. Additionally, the tensile stress is reduced as there is less pulling tangentially to the radial direction of the magnet as the centrifugal forces on the portions of the rotor that are 90 degrees away in either direction do not pull the magnets apart in opposite directions.

In specific embodiments of the invention, rotor frame 210 can include pockets 201 that are designed to contain magnets 220. Pockets 201 can assist in keeping magnets 220 in place on rotor 200. Additionally, rotor frame 210 can include spokes 204 between an outer rim and an inner rim of rotor frame 210 to provide additional structural rigidity to rotor 200. Spokes 204 may be connected to outer rim 202. Spokes 204 can be thicker than the main body of rotor frame 210. The main body of rotor frame 210, in the case of side rotor 200, can be referred to as the “back iron” of the rotor because it creates a high permeability return path for the magnetic flux of the rotor magnets even when the main body of the frame is not formed of iron. Spokes 204 can be designed to maintain the structural rigidity of rotor 200 despite the fact the main body of rotor frame 210 is thinner at the points in which pockets 201 are formed. Spokes 204 can prevent the rotor from bending away from the air gap due to the rotational stresses of the rotor. Magnets 220 may be located between spokes 204. Spokes 204 may be located between each permanent magnet 220 in the set of permanent magnets 220. Spokes 204 can also prevent the spreading of magnets 220 around the arc of the rotor by being in contact with both sides of the magnets 220 and preventing the creation of tensile stress from such spreading.

Permanent magnets 220 may include outer surface 203 and inner surface 205. Outer surface 203 of permanent magnets 220 may face away from the center of rotor 200 in a radial direction. Inner surface 205 of permanent magnets 220 may face toward the center of rotor 200 in the radial direction. The outer surface and inner surface of the magnets may also be referred to as an outer edge and an inner edge, respectively, of the magnets.

In specific embodiments of the invention, rotor frame 210 can include outer rim 202. Outer rim 202 can be configured to come into contact with an outer surface 203 (or outer edge) of permanent magnets 220. Outer rim 202 can be configured to form an edge of a pocket 201 on rotor 200. In specific embodiments in which rotor 200 also includes spokes 204, outer rim 202 can be connected to spokes 204. Spokes 204 can be connected to outer rim 202 to add structural rigidity to outer rim 202. In specific embodiments, permanent magnets 220 may be in contact with outer rim 202 and thereby outer rim 202 may prevent magnets 220 from flying out due to centrifugal force acting on the magnets. In specific embodiments, outer rim 202 can be a thicker region of the material that is used to form the main body of rotor 200. In specific embodiments, outer rim 202 can be a reinforced outer rim. In specific embodiments, outer rim 202 can be a reinforced outer rim in the form of a separate piece of material that is fixedly engaged with an outer rim of the main body of rotor frame 210. In specific embodiments, outer rim 202 can be a reinforced outer rim in the form of a locally carburized or heat-treated portion of rotor frame 210 to increase the strength of the material at the outer rim of rotor frame 210. Outer rim 202 can be thicker than the main body of rotor frame 210. Outer rim 202 can be made of stronger material than the remainder of rotor frame 210 to provide additional structural rigidity and to prevent permanent magnets 220 from being pulled outward with the rotation of rotor 200.

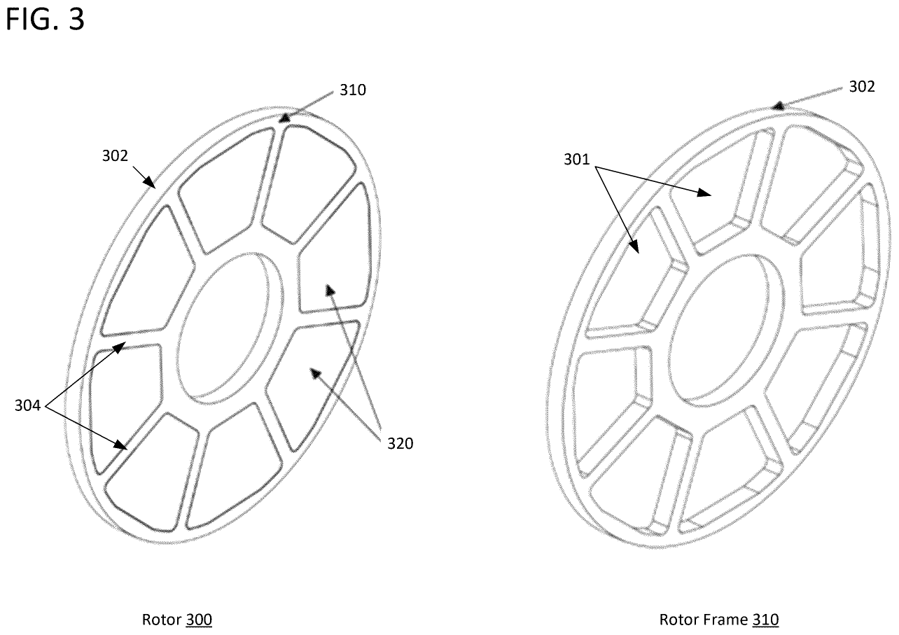

FIG. 3 illustrates an example of center rotor 300 and center rotor frame 310 in accordance with specific embodiments of the inventions disclosed herein. Center rotor 300 may be an example of center rotor 114 or 123. Rotor 300 shows permanent magnets 320 placed in pockets 301 of rotor frame 310. Rotor frame 310 may be a nonmagnetic structure. In specific embodiments, aspects or features of center rotor 300 may be similar to side rotor 200. For example, center rotor may also include segmented magnets, pockets, spokes, an outer rim, etc. As illustrated, rotor 300 includes spokes 304, outer rim 302, and pockets 301 for magnets 320. However, in center rotor 300, the back iron of rotor frame 310 is entirely removed in the locations of pockets 301, such that pockets 301 are through-holes. Regardless of the lack of back iron, spokes 304 and outer rim 302 of rotor 300 can still exhibit the features described herein in terms of increasing the structural rigidity of the rotor and limiting the tensile stress imparted to the permanent magnets.

In specific embodiments, the rotor frame (such as rotor frames 210 and 310) can be formed of various materials depending upon the use case for the rotor. In specific embodiments in which a rotor includes spokes or in which a rotor includes an outer rim, the different portions of the rotor can be formed of different materials. In specific embodiments, the rotor frame can be formed of soft magnetic steel such as low carbon steel (e.g., less than 0.3% carbon by mass). In specific embodiments, the main body of the rotor frame can be formed of soft magnetic steel such as low carbon steel while different portions of the rotor frame are made of, or reinforced by, higher strength materials such as higher strength steel or carbon fiber. For example, if the rotor included spokes or an outer rim, either or both of those components could be made of such higher strength materials or be reinforced with higher strength materials. In specific embodiments, the spokes or outer rim of the rotor can be made of materials with low permeability to reduce magnetic flux leakage. The spokes or outer rim of the rotor can be made of any diamagnetic material. However, using a low electrical resistivity material could lead to increased eddy currents and reduced efficiency.

In specific embodiments, the rotor frame and the components thereof can be made of different material depending on whether the rotor is a side rotor or center rotor. For side rotors such as side rotor 200, the rotor frame can be made from a magnetic material such as magnetic grade steel to create an easy path for magnetic flux from two neighboring magnetic poles. This enhances the airgap magnetic flux and thereby creates more torque. For center rotors such as center rotor 300, the rotor frame and its components can be made of non-magnetic structural material as flux passes through and is only in an axial direction. In specific embodiments, the rotor frame can be made of non-magnetic structural materials such as aluminum alloys. However, in embodiments in which the material is non-magnetic, the rotor can include eddy currents under the influence of the magnetic field. To reduce these eddy currents, the rotor frame can be made of materials with high electrical resistivity such as composite materials or high electrical resistivity alloys (e.g., stainless steel, nichrome, etc.).

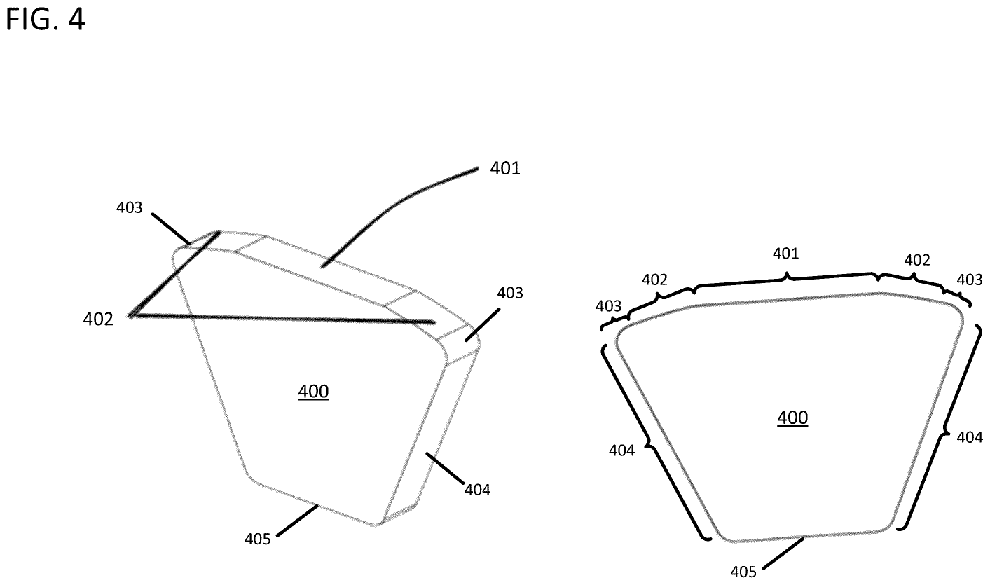

FIG. 4 illustrates an example of permanent magnet 400 in two different views in accordance with specific embodiments of the inventions disclosed herein. Magnet 400 may include flat face 401, arc faces 402, rounded corners 403, sides 404, and inner surface 405. Flat face 401 and arc faces 402 (and, in specific embodiments, rounded corners 403) may make up the outer surface of magnet 400. Magnet 400 may be representative of a set of magnets in a rotor. In specific embodiments, permanent magnet 400 can be shaped to reduce the tensile stress imparted to the permanent magnet during high-speed operation. Magnet 400 may be a ceramic magnet or a rare earth magnet. Sets of magnets used in rotors may have different dimensions. For example, a set of neodymium magnets may be 3.5 mm thick in the axial direction.

In specific embodiments, magnet 400 can include flat face 401 at the portion of the magnet facing the outer rim. Accordingly, flat face 401 may be referred to as a flat outer face. Flat face 401 may be in contact with the outer rim of the rotor frame. As a result of the flat face, the manufacturing process has lower precision requirements (e.g., compared to creating a precision machined arc) to ensure uniform contact with the rim around the arc of the rotor. Using flat face 401 eliminates the possibility of a point contact which could overly stress magnet 400.

In specific embodiments, the entire top surface of the magnet could be flat. However, this might overly reduce the total magnet area, thereby reducing torque between the stator and rotor. Accordingly, in specific embodiments, permanent magnet 400 also includes arc faces 402 bracketing flat face 401 to at least partially increase the surface area of the rotor that is covered by the set of permanent magnets 400. Arc faces 402 may extend from flat face 401 in both directions around an arc defined by the rotor. Arc faces 402 may also be referred to as curved outer faces. In specific embodiments, arc faces 402 may connect flat face 401 to rounded corners 403. In specific embodiments, magnet 400 may not include arc faces 402, such that flat face 401 connects directly to rounded corners 403.

In specific embodiments, magnet 400 can also include rounded corners 403 that connect the top face (either the flat face alone or the flat face combined with the arc faces) with the sides 404 of magnet 400. Rounded corners 403 can provide a point at which adhesive can be injected in accordance with the embodiments described herein in which the permanent magnets are attached to the frame via adhesive.

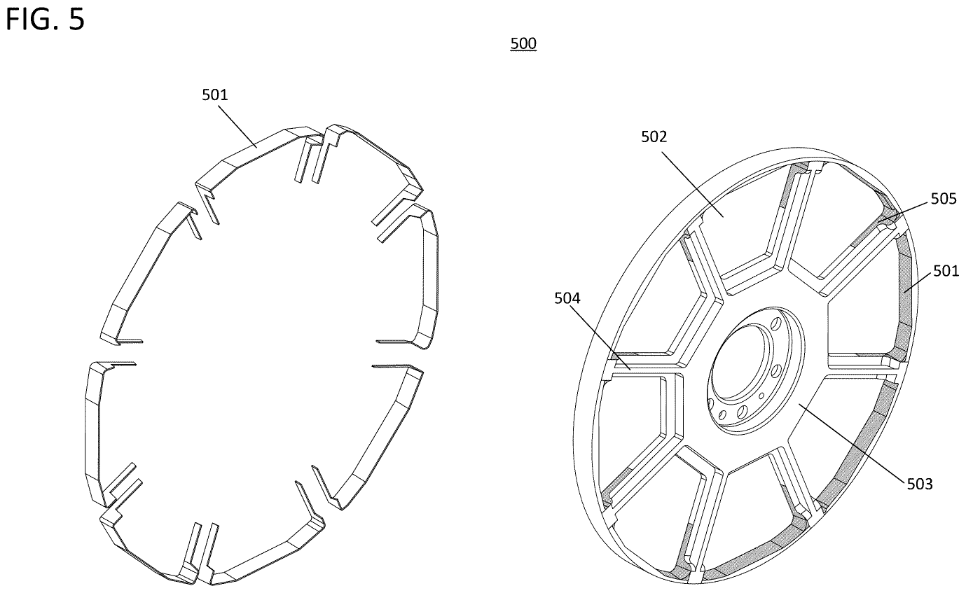

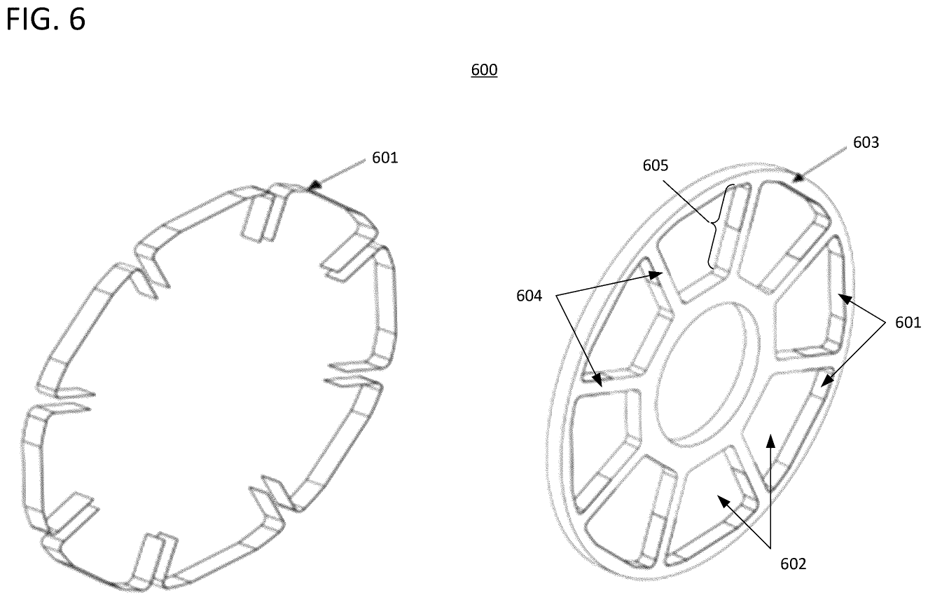

FIGS. 5 and 6 illustrate examples of an adhesive pattern to adhere permanent magnets to rotors in accordance with specific embodiments of the inventions disclosed herein. In specific embodiments, the permanent magnets can be adhered to the rotor frame in a specific pattern to reduce the tensile stress experienced by the permanent magnets. In specific embodiments, the permanent magnets can be adhered to the rotor frame only by an outer edge of the magnets. In specific embodiments, the permanent magnets can be adhered to the rotor frame on outer edge of the magnets and on a portion of the sides of the permanent magnets. In these embodiments, the tensile stress experienced by the outer portion of the magnet is reduced because the centrifugal force is not countered by a countervailing force caused by adhesive on the inner edge of the magnet. The portion of the sides with adhesive can be less than 50% of the sides. In these embodiments, the tensile stress experienced by the outer portion of the magnet is reduced because the centripetal force is not countered by a countervailing force caused by adhesive on the lower half (e.g., inside half, towards the center) of the sides of the magnets or on the inner edge of the magnet. For example, the absence of glue on the radially-inner side of the magnet may avoid putting the magnet in tension (against which the magnet may be weak) due to centripetal adhesive forces. The spinning rotor may substantially but the magnet in compression (against which the magnet is strong) with centrifugal forces; and the centripetal forces keeping the magnet in place in the rotor may be from the outer rim (and spokes) of the rotor.

The adhesive may be strong enough to keep the permanent magnets attached to the rotor frame. When the motor is in operation, the permanent magnets may “feel” a momentary force (e.g., pull) axially towards the stator. For example, the magnets may “feel” a pull of up to 192.6 N (e.g., 20 kg). In other examples, the magnets may be subjected to a different magnitude of force towards the stator.

The suitability of an adhesive for use may be determined, in part, based on rotor dimensions. If the magnets were to be circumferentially bonded to the rotor frame (e.g., a complete ring magnet), the area of contact of the magnets to the rotor frame may be approximately Pi multiplied the diameter of the rotor frame multiplied by the thickness of the rotor pockets. For example, if the diameter is 0.1416 m and the thickness is 0.006 m, the area of contact may be approximately 2.669*10⁻³ m². In this example, shear strength may be estimated as half of tensile strength. In this example, a shear strength of the adhesive may be approximately 16 MPa. To break the strength of the adhesive over the contact area, a shear force of the strength of the adhesive (16 MPa) multiplied by the contact area (2.669*10⁻³ m²) may be required. Accordingly, the force required to shear the adhesive with that contact area may be approximately 43520.98 N. This is significantly higher than the force acting on the magnets, which is 196.2 N in this example. This affirms that the axial force of 196.2 N on the magnet may not be sufficient to break the bond between the magnet and the rotor back plate. In this example, the adhesive may be any adhesive with a shear strength of at least 196.2 N; the pattern of adhesive may adhere the set of permanent magnets to the rotor frame with a strength that withstands an axial force of 196.2 N.

In specific embodiments, the example described above for calculating the suitability of an adhesive may be altered. For example, the magnets may not take up the whole portion of the circumference of the rotor (e.g., magnets may be segmented or divided), the magnets may not be curved in line with the circumference (e.g., have a combination of straight edges), adhesive may also be placed on the sides of the magnets (e.g., in addition to the outer edges of the magnets), etc. The calculation for the contact area may be adjusted according to different adhesive geometries. Due to differences in geometry and adhesive patterns, the adhesive may have different strength requirements in different rotor designs. In specific embodiments, the adhesive may be any adhesive with a shear strength of at least 190 N; the pattern of adhesive may adhere the set of permanent magnets to the rotor frame with a strength that withstands an axial force of 190 N (or more). In specific embodiments, the adhesive may be an adhesive that adheres the set of permanent magnets to the rotor frame with a strength that exceeds the maximum possible magnetic pull from the stator. The strength of the adhesive may be only a factor in determining the suitability of an adhesive. Other factors such as thermal properties (e.g., thermal expansion, melting point), magnetic properties, and physical properties may be considered. For example, a suitable adhesive may remain intact for temperatures up to 500 F.

In specific embodiments, the adhesive used to bond the magnet to the rotor may be a JB Weld epoxy/resin combination which has a tensile strength of 4730 psi (32.6122 MPa). The magnet may be a ferrite magnet. The type of adhesive may depend on the type of magnet used. For example, Permabond TA437 may be used for Ferrite magnets and High Temp 550F JB Weld may be used for Neodymium magnets.

FIG. 5 illustrates adhesive pattern 500 on an end rotor in accordance with specific embodiments of the inventions disclosed herein. The figure on the left illustrates adhesive pattern 500 alone while the figure on the right includes rotor frame 503 (without magnets). As illustrated, adhesive 501 coats a portion of rotor frame 503 that will contact an outer surface of permanent magnets that are placed in pockets 502. The outer surface of the permanent magnets may face away from the center of the rotor in a radial direction. Adhesive 501 may not be (e.g., may refrain from being) in contact with an inner surface of the permanent magnets. The inner surface of the permanent magnets may face toward the center of the rotor in the radial direction. Adhesive pattern 500 may be in contact with a portion of side surfaces 505 of the set of permanent magnets but may not be (e.g., may refrain from being) in contact with more than 50% of each side surface 505 (e.g., to prevent the adhesive on the radially-inner side of the magnet and the centrifugal force of the rotating rotor from adding tensile stress in a radial direction). The portion of the side surface 505 that is in contact with adhesive 501 may be closer to the outer surface of the set of permanent magnets than to the inner surface of the set of permanent magnets. Adhesive 501 may extend down the sides of pockets 502 (e.g., the sides of the magnets) on either side by coating a portion of spokes 504. Furthermore, adhesive 501 may not cover the entire height of spokes 504 after a certain point because there may be an intentional air gap (e.g., due to a ledge or divot) between the magnets and the spokes in specific embodiments. Adhesive pattern 500 may not be (e.g., may refrain from being) on a back side surface of the set of permanent magnets. For example, there may not be any adhesive 501 on the back of pockets 502.

FIG. 6 illustrates adhesive pattern 600 on a center rotor in accordance with specific embodiments of the inventions disclosed herein. The figure on the left illustrates adhesive pattern 600 alone while the figure on the right includes rotor frame 603 (without magnets). As illustrated, adhesive 601 coats a portion of rotor frame 603 that will contact an outer surface of the permanent magnets. The outer surface of the permanent magnets may face away from the center of the rotor in a radial direction. Adhesive 601 may not be (e.g., may refrain from being) in contact with an inner surface of the permanent magnets. The inner surface of the permanent magnets may face toward the center of the rotor in the radial direction. Adhesive pattern 600 may be in contact with a portion of side surfaces 605 of the set of permanent magnets but may not be (e.g., may refrain from being) in contact with more than 50% of each side surface 605 (e.g., to prevent the adhesive on the radially-inner side of the magnet and the centrifugal force of the rotating rotor from adding tensile stress in a radial direction). The portion of the side surface 605 that is in contact with adhesive 601 may be closer to the outer surface of the set of permanent magnets than to the inner surface of the set of permanent magnets. Adhesive 601 may coat a portion of the sides of pockets 602 (e.g., the sides of the magnets). Adhesive 601 may extend down the sides of the magnets on either side by coating a portion of spokes 604.

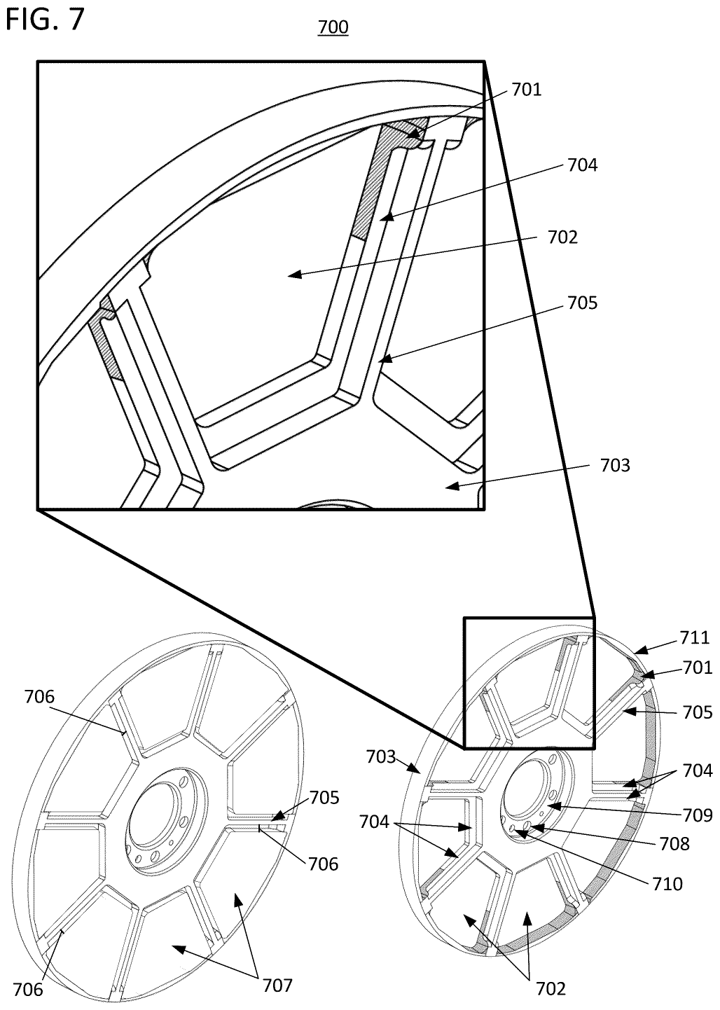

FIG. 7 illustrates an example of adhesive pattern 700 as well as ledges 704 that create air gaps 706 between magnets 707 and spokes 705 in accordance with specific embodiments of the inventions disclosed herein. Magnets 707 may be placed in pockets 702. Air gap 706 may be between a side of magnets 707 and spokes 705 on the surface of the rotor that faces the stator. Ledge 704, on three sides of a pocket 702, can form air gap 706. In specific embodiments, magnets 707 may contact the sides of ledges 704. FIG. 7 shows examples of additional details of a rotor that are in accordance with specific embodiments of the inventions disclosed herein. In particular, FIG. 7 shows bolt holes 708, flat face 709, and dowel holes 710 for connecting the rotor to a shaft and positioning the shaft thereon. The rotor also shows outer rim 711 of the rotor, adhesive 701, spokes 705, and pockets 702. Adhesive 701 may adhere magnet 707 to rotor frame 703. Spokes 705 may also be called radial ribs or stiffeners. Pockets 702 may be for magnet seating. Flat face 709 of the rotor may be for bolting the rotor to a shaft flange. Bolt holes 708 may be for fastening the rotor to the flange. Dowel holes 710 may be for positioning rotors. The illustrated rotor of FIG. 7 can be used as an end rotor in a single or tandem yokeless motor.

Magnets 707 may be placed in pockets 702 such that magnets 707 are surrounded by ledges 704 and outer rim 711 of rotor frame 703. Outer rim 711 may also be referred to as, or be a part of, an external wall on the rotor. Magnets 707 may include a set of flat outer faces that are in contact with outer rim 711 of rotor frame 703. In specific embodiments, each magnet 707 may contact the sides of ledges 704 that correspond to the pocket 702 containing the magnet 707.

Air gaps 706 may be located between permanent magnets 707 and spokes 705. Air gaps 706 may be formed by a set of ledges 704. Ledges 704 may also be considered divots in spokes 705. Air gaps 706 may contribute to multiple benefits. Air gaps 706 can assist with placing each magnet 707 into the corresponding pocket 702 formed by ledges 704 and spokes 705 of rotor frame 703. Additionally, air gaps 706 can increase the performance of the electric motor. In specific embodiments, the air gaps do not extend all the way down to the surface of the main body of rotor frame 703 so that there is a point at which the magnet is in contact with spokes 705 (e.g., the sides of ledges 704) and can thereby be adhered to spokes 705 using adhesive 701.

In specific embodiments, adhesive 701 may be applied to rotor frame 703. In specific embodiments, adhesive 701 may coat all, a portion, or none of the sides of ledge 704. In FIG. 7, adhesive 701 is shown to coat a portion of the sides of ledge 704 as well as a portion of spokes 705 where ledges 704 do not extend. Adhesive 701 is also shown to coat the portion of pockets 702 close to outer rim 711.

In alternative approaches, adhesive can be applied to the back of the magnets (e.g., between the main body of the rotor and the magnets, at the side of the pockets with the largest surface area). However, in these approaches it can be difficult to maintain a flatness of the rotor face that faces the stator. Additionally, this may introduce tensile stress on the magnets which can lead to cracking. In alternative approaches, the entire pocket can be filled with potting material. However, this can create excess local stress in areas of the magnet that are closer to the rotating axis and cause the magnet to crack at higher speeds. In alternative approaches, a ring magnet can be used which is magnetized in the desired pole pattern. However, this may create excess tensile stress in magnets at relatively lower speeds as compared to approaches in which the magnet is segmented.

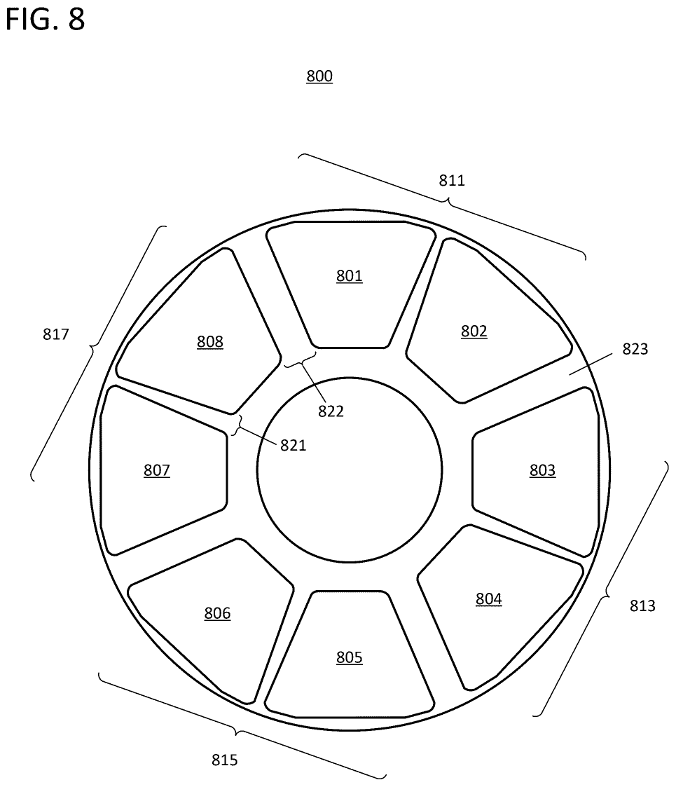

FIG. 8 illustrates an example of 4-pole rotor 800 in accordance with specific embodiments of the inventions disclosed herein. Rotor 800 may include a set of magnets divided into pairs. Magnet 801 and magnet 802 form pair 811, magnet 803 and magnet 804 form pair 813, magnet 805 and magnet 806 form pair 815, and magnet 807 and magnet 808 form pair 817. Pairs of magnets may have the same polarity, with pairs having alternating polarity. For example, magnets 801 and 802 may have the same polarity (e.g., north pole); magnets 803 and 804 may have the same polarity (e.g., south pole), opposite that of magnets 801 and 802; magnets 805 and 806 may have the same polarity (e.g., north pole), opposite that of magnets 803 and 804; and magnets 807 and 808 may have the same polarity (e.g., south pole), opposite that of magnets 805 and 806. Magnets 801 through 808 may be shaped similarly to other magnets described herein (e.g., with a flat face, arc faces, rounded corners, etc.). Magnets 801 through 808 may be ceramic magnets (e.g., ferrite magnets) or rare earth magnets (e.g., neodymium magnets).

Magnets 801 through 808 may be arranged on rotor frame 823 with nonuniform spacing. That is, spacing 821 between magnets within pairs of magnets may be different (e.g., smaller) than spacing 822 between pairs of magnets. Spacing 821 between magnets and spacing 822 between pairs of magnets may include a range of distances (e.g., spacing may vary at different radial distances from the center of rotor 800). However, spacing may be such that spacing 821 may be smaller than spacing 822 when compared at the same radial distances from the center of rotor 800.

Permanent magnets 801 through 808 may be located between spokes. In specific embodiments, spokes may be located between magnets in pairs of magnets (e.g., between magnets 801 and 802; between magnets 803 and 804; between magnets 805 and 806; and between magnets 807 and 808). In specific embodiments, spokes may not be (e.g., may refrain from being) located between pairs of magnets (e.g., between magnets 802 and 803; between magnets 804 and 805; between magnets 806 and 807; and between magnets 808 and 801). That is, spokes may be located in spacings 821 but not in spacings 822. By not including spokes in spacings 822, rotor 800 may have reduced weight and therefore may be more energy efficient.

In specific embodiments, rotor frame 823 can be formed of various materials depending upon the use case for the rotor. In specific embodiments in which a rotor includes spokes or in which a rotor includes an outer rim, the different portions of the rotor can be formed of different materials. In specific embodiments, the rotor frame can be formed of soft magnetic steel such as low carbon steel (e.g., less than 0.3% carbon by mass). In specific embodiments, the main body of the rotor frame can be formed of soft magnetic steel such as low carbon steel while different portions of the rotor frame are made of, or reinforced by, higher strength materials such as higher strength steel or carbon fiber. For example, if the rotor included spokes or an outer rim, either or both of those components could be made of such higher strength materials or be reinforced with higher strength materials. In specific embodiments, the spokes or outer rim of the rotor can be made of materials with low permeability to reduce magnetic flux leakage. The spokes or outer rim of the rotor can be made of any diamagnetic material. However, using a low electrical resistivity material could lead to increased eddy currents and reduced efficiency.

In specific embodiments, the rotor frame and the components thereof can be made of different material depending on whether the rotor is a side rotor or center rotor. For side rotors, the rotor frame can be made from a magnetic material such as magnetic grade steel to create an easy path for magnetic flux from two neighboring magnetic poles. This enhances the airgap magnetic flux and thereby creates more torque. For center rotors, the rotor frame and its components can be made of non-magnetic structural material as flux passes through and is only in an axial direction. In specific embodiments, the rotor frame can be made of non-magnetic structural materials such as aluminum alloys. However, in embodiments in which the material is non-magnetic, the rotor can include eddy currents under the influence of the magnetic field. To reduce these eddy currents, the rotor frame can be made of materials with high electrical resistivity such as composite materials or high electrical resistivity alloys (e.g., stainless steel, nichrome, etc.).

In specific embodiments of the invention, rotor frame 823 can include an outer rim. In specific embodiments in which rotor frame 823 also includes spokes, the outer rim can be connected to the spokes. In specific embodiments, the outer rim can be a thicker region of the material that is used to form the main body of rotor 800. The outer rim can be made of stronger material than the remainder of rotor frame 823 to provide additional structural rigidity and to prevent permanent magnets 801 through 808 from being pulled outward with the rotation of rotor 800. In specific embodiments, the outer rim can be a reinforced outer rim. In specific embodiments, the outer rim can be a reinforced outer rim in the form of a separate piece of material that is fixedly engaged with an outer rim of the main body of rotor frame 823. In specific embodiments, the outer rim can be a reinforced outer rim in the form of a locally carburized or heat-treated portion of rotor frame 823 to increase the strength of the material at the outer rim of rotor frame 823.

The adhesive used to adhere permanent magnets 801 through 808 to the rotor frame may be strong enough to withstand shear forces (e.g., pull) axially towards the stator when the motor is in operation. For example, the magnets may “feel” a pull of approximately 190 N (e.g., 20 kg). In other examples, magnets 801 through 808 may be subjected to a different magnitude of force towards the stator. The axial force of approximately 190 N on magnets 801 through 808 may not be sufficient to break the bond between magnets 801 through 808 and rotor frame 823 (e.g., including spokes, ledges, back iron, and outer rim, as applicable with the specific geometry of rotor 800 and adhesive pattern). The adhesive may be an adhesive with a shear strength of at least 190 N; the pattern of adhesive may adhere the set of permanent magnets 801 through 808 to rotor frame 823 with a strength that can withstand an axial force of 190 N (or more). For example, the adhesive may be a JB Weld epoxy/resin combination which has a tensile strength of 4730 psi (32.6 MPa) and may have a shear strength of approximately 16 MPa. The type of adhesive may depend on the type of magnet used. For example, Permabond TA437 may be used for Ferrite magnets and High Temp 550F JB Weld may be used for Neodymium magnets.

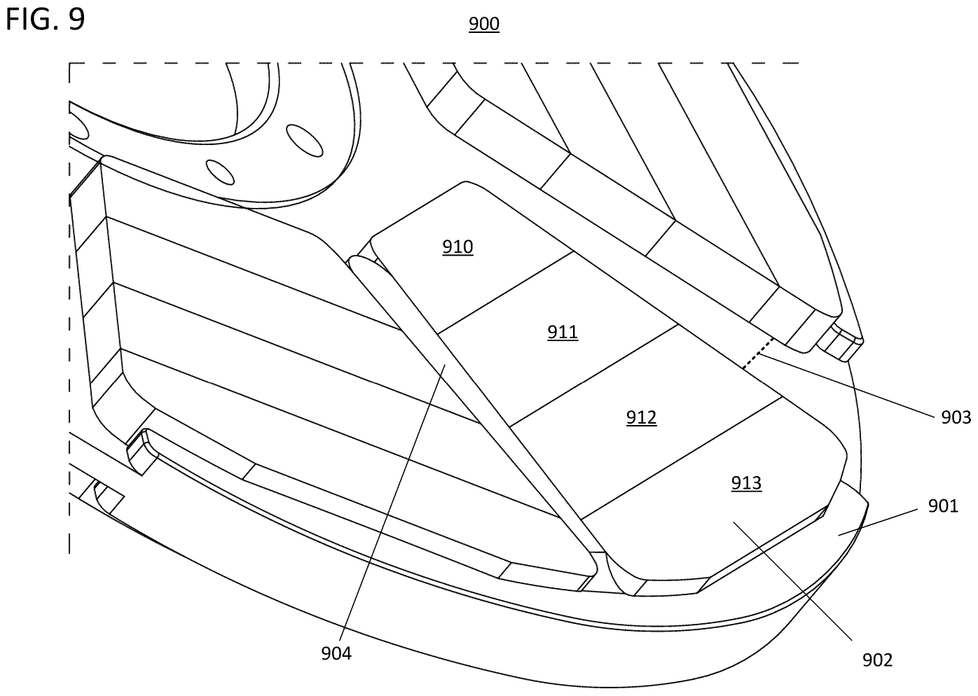

FIG. 9 illustrates an example of a design for reducing flux leakage for a 4-pole rotor 900 in accordance with specific embodiments of the inventions disclosed herein. Flux leakage may be reduced by reducing the outer lip 901, making magnet 902 slightly prod of the surface of the rotor frame. Outer lip 901 may be part of, or attached to, an outer rim. In specific embodiments, magnets 902 may be monolithic or may be segmented. Magnets 902 may be non-ferrite (e.g., Neodymium magnets (NdFeB)). Gap 903 separates pairs of magnets 902. Each pair of magnets 902 may have the same polarity; and alternating pairs may have alternating polarities. Gap 903 may, therefore, separate a North Pole from a South Pole of rotor 900.

Each magnet 902 may be segmented into multiple discrete magnet segments 910, 911, 912, and 913 arranged in a radial direction. Each discrete magnet segment 910 through 913 may be electrically insulated using epoxy. By segmenting magnets 902 as shown, eddy currents that are formed when the rotor spins may be broken. Each segment 910 through 913 may have different shapes and dimensions but may each be roughly the same length (e.g., 8.5 mm) radially.

The outer rim may form a pocket to receive the angled edges of magnet 902. Adhesive may fill any gaps between magnets 902 and the outer rim. In specific embodiments, magnets 902 may adhere to rotor frame via adhesive on the side of the pocket formed by the outer rim. In specific embodiments, adhesive may also be applied to the sides of spokes 904. In specific embodiments, adhesive may be applied to a portion of each side of spokes 904, the portion with adhesive may be the portion of the side of the spoke 904 that is closer to the outer rim than to the center. In specific embodiments, the portion of the side of the spoke with adhesive may be less than 50% of the side of the spoke.

Permanent magnets 902 may protrude from the rotor frame in an axial direction. Due to magnets 902 protruding from the rotor frame, inductive loss from the magnetic loop closing too soon may be prevented. Outer lip 901 may be made smaller axially (e.g., such that magnets 902 protrude even more from the rotor frame). A smaller outer lip may cause additional stress per unit area on the magnet edge. However, this stress is compressive strain on the magnet, which may be easily handled by the magnets. For example, ceramic magnets such as ferrite magnets exhibit excellent compressive strength (e.g., approximately 700 MPa of compressive strength). Outer lip 901 may be made taller axially (e.g., such that magnets 902 protrude less relative to the outer lip). This may reduce strain on the magnets; however, it may also increase the weight of the rotor, decreasing efficiency. Sets of magnets used in rotors may have different dimensions. For example, a set of neodymium magnets may be 3.5 mm thick in the axial direction.

Rotors may include a variety of spoke arrangements. In specific embodiments, a rotor may not have spokes. In specific embodiments, the rotor magnets may be located between spokes. In specific embodiments, a rotor (e.g., an 8-pole rotor) may have one magnet between each pair of spokes, such that the rotor alternates magnets and spokes in a circular direction. In specific embodiments, a rotor (e.g., a 4-pole rotor) may have spokes between magnets in pairs of magnets having the same polarity. In specific embodiments, a rotor may also have spokes between the pairs of magnets. Using fewer spokes may reduce the weight of the rotor. To maintain stability when the number of spokes is reduced, the body of the rotor may be made thicker.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, although motors were generally discussed, similar principles may be applied to generators. These and other modifications and variations to the present invention may be practiced by those skilled in the art, without departing from the scope of the present invention, which is more particularly set forth in the appended claims.

What is claimed is:

1. A rotor for an axial electric machine comprising:
a rotor frame;
a set of permanent magnets; and
a pattern of adhesive that adheres the set of permanent magnets to the rotor frame, and that is in contact with an outer surface of the set of permanent magnets and is not in contact with an inner surface of the set of permanent magnets;
wherein: (i) the outer surface faces away from a center of the rotor in a radial direction of the axial electric machine; and (ii) the inner surface faces towards the center of the rotor in the radial direction of the axial electric machine.

2. The rotor of claim 1, wherein:
the pattern of adhesive is in contact with a portion of a side surface of the set of permanent magnets but is not in contact with more than 50% of the side surface; and
the portion of the side surface is closer to the outer surface of the set of permanent magnets than to the inner surface of the set of permanent magnets.

3. The rotor of claim 1, wherein:
the pattern of adhesive is not on a back side surface of the set of permanent magnets.

4. The rotor of claim 1, wherein:
the set of permanent magnets are ceramic magnets.

5. The rotor of claim 1, wherein:
the set of permanent magnets are neodymium magnets.

6. The rotor of claim 1, wherein:
the rotor is used with a stator; and
the pattern of adhesive adheres the set of permanent magnets to the rotor frame with a strength that exceeds the maximum possible magnetic pull from the stator.

7. A rotor for an axial electric machine comprising:
a rotor frame;
a set of permanent magnets;
a set of pockets formed in the rotor frame, wherein the set of permanent magnets are placed in the set of pockets; and
an outer rim of the rotor frame, wherein the set of permanent magnets includes a set of flat outer faces, and the set of flat outer faces are in contact with the outer rim of the rotor frame.

8. The rotor of claim 7, wherein:
the set of permanent magnets are ceramic magnets.

9. The rotor of claim 7, wherein:
the set of permanent magnets are neodymium magnets.

10. The rotor of claim 7, wherein:
the set of permanent magnets include a set of curved outer faces that extend from the set of flat outer faces in both directions around an arc defined by the rotor.

11. The rotor of claim 10, wherein:
the set of curved outer faces connect the set of flat outer faces to a set of rounded corners.

12. The rotor of claim 7, wherein:
the set of permanent magnets protrude from the rotor frame in an axial direction.

13. The rotor of claim 7, wherein:
each magnet in the set of permanent magnets includes multiple discrete magnet segments arranged in a radial direction.

14. A rotor for an axial electric machine comprising:
a rotor frame;
a set of permanent magnets;
a set of spokes on the rotor frame; and
an outer rim of the rotor frame, wherein the set of spokes are connected to the outer rim;
wherein the permanent magnets in the set of permanent magnets are located between the spokes in the set of spokes.

15. The rotor of claim 14, wherein:
the rotor frame is made of a soft magnetic material; and
the outer rim is a reinforced rim made of one of higher strength steel and carbon fiber.

16. The rotor of claim 14, wherein:
the outer rim is a reinforced rim made of a locally carburized or heat-treated portion of the rotor frame.

17. The rotor of claim 14, wherein:
the rotor frame is made of one of stainless steel and nichrome.

18. The rotor of claim 14, further comprising:
a set of air gaps wherein the air gaps in the set of air gaps are located between the permanent magnets in the set of permanent magnets and the spokes in the set of spokes;
wherein the set of air gaps are formed by a set of divots in the spokes.

19. The rotor of claim 14 wherein:
the spokes in the set of spokes are located between each permanent magnet in the set of permanent magnets.

20. The rotor of claim 14 wherein:
the set of permanent magnets is divided into a set of pairs of magnets;
both magnets in the pairs of magnets in the set of pairs of magnets have the same polarity; and
the spokes in the set of spokes are located between the magnets in the pair of magnets.
